(19) United States
(12) Patent Application Publication
(10) Pub. No.: US 2013/0208224 A1
(43) Pub. Date: Aug. 15, 2013

(54) LIQUID CRYSTAL DISPLAY APPARATUS

(71) Applicants: Yuko Kizu, Yokohama-shi (JP); Hajime Yamaguchi, Kawasaki-shi (JP); Yukio Kizaki, Kawasaki-shi (JP); Masao Tanaka, Sagamihara-shi (JP); Machiko Ito, Yokohama-shi (JP)

(72) Inventors: Yuko Kizu, Yokohama-shi (JP); Hajime Yamaguchi, Kawasaki-shi (JP); Yukio Kizaki, Kawasaki-shi (JP); Masao Tanaka, Sagamihara-shi (JP); Machiko Ito, Yokohama-shi (JP)

(21) Appl. No.: 13/586,947

(22) Filed: Aug. 16, 2012

Related U.S. Application Data
(63) Continuation of application No. PCT/JP10/00967, filed on Feb. 17, 2010.

(51) Int. Cl. G02F 1/1343

(52) U.S. Cl. CPC G02F 1/134336
USPC 349/143

(57) ABSTRACT

According to one embodiment, an apparatus includes a support substrate, first electrodes, second electrodes, a counter substrate, and a liquid crystal layer. The first and second electrodes are provided on a surface of the support substrate. The first and second electrodes are alternately arranged. A counter substrate opposes the surface. The liquid crystal layer is held between the support substrate and the counter substrate. 0.7≦D/(L+S)≦2 is satisfied. L is an average width of at least two of the first electrodes and at least two of the second electrodes. S is an average distance between at least two pairs of adjacent ones of the first and second electrodes. D is a distance between the support substrate and the counter substrate.

### CROSS-REFERENCE TO RELATED APPLICATIONS

This application is a Continuation application of PCT Application No. PCT/JP2010/000967, filed Feb. 17, 2010, the entire contents of which are incorporated herein by reference.

### FIELD

Embodiments described herein relate generally to a liquid crystal display technique.

### BACKGROUND

Liquid crystal display apparatuses utilizing a liquid crystal layer exhibiting the Kerr effect have been proposed for realizing quick response. The Kerr effect is an effect that the refractive index of a transparent isotropic medium exhibits anisotropy proportional to the square of an external electric field. The Kerr effect is exhibited by a polar liquid material that is not a liquid crystal material. However, in the case of the liquid crystal material, molecules have the property of making cooperative motions to the external electric field, and therefore amplification of the Kerr effect can be expected. Further, since the liquid crystal material exhibiting the Kerr effect has a short correlation length as a typical length in a liquid crystal region in which the molecules make cooperative motions, it exhibits a high-speed electric field response of not more than several milliseconds. As liquid crystal phases exhibiting the Kerr effect, cholesteric blue phase, smectic blue phase, pseudo isotropic phase, etc., are known.

JP-A 2008-241947 (KOKAI) discloses a technique of sufficiently increasing the thickness (cell gap) of the liquid crystal layer exhibiting the Kerr effect to completely cover the range in which the electric field is strong, thereby reducing the specification restraints of a counter substrate.

### BRIEF DESCRIPTION OF THE DRAWINGS

FIG. 1 is a plan view schematically illustrating a liquid crystal display apparatus according to an embodiment;

FIG. 2 is an exploded perspective view illustrating a liquid crystal panel shown in FIG. 1;

FIG. 3 is a cross-sectional view schematically illustrating a structure example to be employed in the liquid crystal panel of the liquid crystal display apparatus shown in FIG. 2;

FIG. 4A is a schematic cross-sectional view illustrating a liquid crystal display panel for a liquid crystal display apparatus according to example 1;

FIG. 4B is a schematic cross-sectional view illustrating a liquid crystal display panel for a liquid crystal display apparatus according to example 2;

FIG. 4C is a schematic cross-sectional view illustrating a liquid crystal display panel for a liquid crystal display apparatus according to example 3;

FIG. 5A is a graph illustrating the relationship between the cell gap and the transmittance;

FIG. 5B is a graph illustrating the relationship between the cell gap and the coefficient of fluctuation of the transmittance;

FIG. 5C is another graph illustrating the relationship between the cell gap and the transmittance;

FIG. 5D is another graph illustrating the relationship between the cell gap and the coefficient of fluctuation of the transmittance; and

FIG. 6 is a graph illustrating the relationship between the electrode pitch and the effective cell gap.

### DETAILED DESCRIPTION

In general, according to one embodiment, a liquid crystal display apparatus includes a flat support substrate, a plurality of first electrodes, a plurality of second electrodes, a counter substrate, and a liquid crystal layer. The first electrodes are provided on a surface of the support substrate. The second electrodes are provided on the surface of the support substrate. The first electrodes and the second electrodes are alternately arranged. A counter substrate opposes the surface on which the first electrodes and the second electrodes are arranged. The liquid crystal layer is held between the support substrate and the counter substrate and exhibits Kerr effect. 0.7≦D/(L+S)≦2 is satisfied. L is an average width of at least two of the first electrodes and at least two of the second electrodes as viewed in a direction in which the first electrodes and the second electrodes are arranged. S is an average distance between at least two pairs of adjacent ones of the first electrodes and the second electrodes. D is a distance between the support substrate and the counter substrate.

The embodiment can enhance the efficiency of use, for display, of the liquid crystal layer exhibiting the Kerr effect, to thereby enhance the display contrast and display speed of the liquid crystal display apparatus.

An explanation will firstly be given of a method of performing transmissive contrast display in a liquid crystal display apparatus utilizing the Kerr effect. A liquid crystal material exhibiting the Kerr effect is placed between a pair of polarizing plates that have optical axes perpendicular to each other (crossed Nicol prisms). When no voltage is applied to the liquid crystal material, the light entering one of the polarizing plates passes straight through the liquid crystal material and is then blocked by the other polarizing plate, since the liquid crystal material has an optically isotropic property. Thus, dark display is realized. On the other hand, when an electric field (transverse electric field) parallel to the polarizing plates is applied to the liquid crystal layer at an angle of 45° with respect to the optical axes of the polarizing plates, the Kerr effect manifests itself to thereby cause optical retardation in a direction parallel to the applied electric field. Namely, the orientation of the liquid crystal material changes in response to the applied electric field, whereby a phase difference occurs between the light incident on the liquid crystal material and the light passing therethrough. By adjusting the optical retardation (phase difference) to approx. 275 nm, bright display is realized.

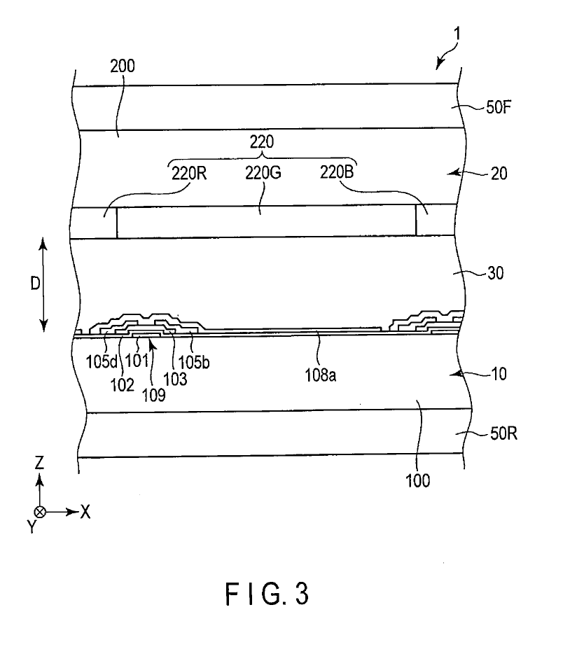

To apply the transverse electric field to the liquid crystal layer, an in-plane switching (IPS) mode structure (see FIG. 3), a fringe field switching (FFS) mode structure (not shown), etc., are utilized. In the IPS mode structure, pixel electrodes and counter electrodes are arranged in a comb shape on one of a pair of substrates that hold a liquid crystal layer therebetween. In the FFS mode structure, a plate-shape counter electrode is provided on one of a pair of substrates, and pixel electrodes are arranged in a comb shape on the counter electrode via an insulating layer interposed therebetween.

Unlike a longitudinal electric field applying mode, such as vertically aligned (VA) mode or optically compensated bend (OCB) mode, in which an electric field perpendicular to a substrate is applied thereto, in a transverse electric field applying mode, the region of a liquid crystal layer, in which optical retardation is effectively induced, is greater in the vicinity of the substrate provided with electrodes, and is smaller in the vicinity of the substrate with no electrodes. In particular, this tendency is emphasized when the Kerr effect proportional to the square-root law of the electric field is utilized, and a strong electric field contributing to bright display is limited to the portion very close to the electrode-provided substrate. Accordingly, a high driving voltage is required to effectively induce the optical retardation over the whole liquid crystal layer.

In particular, liquid crystal display apparatuses of IPS mode utilizing the Kerr effect have a problem that a very high driving voltage is required to obtain a sufficient display luminance. For instance, the inventors acquired a finding that 100 V or more driving voltage is needed to obtain a sufficient display luminance in a display element of IPS mode, which is formed of a typical cholesteric blue phase liquid crystal material with a Kerr coefficient of about 0.4 nm/V2 and employs a comb-shaped electrode unit with a pattern cycle of 10 μm.

In the IPS mode, the region in which optical retardation is effectively induced exists between a pixel electrode and a counter electrode. To induce optical retardation using a low driving voltage, it is useful to reduce the pattern cycle of the pixel and counter electrodes (one cycle of cyclically arranged pixel and counter electrodes, i.e., the distance between one end of a pixel electrode and one end of another pixel, electrode positioned with a counter electrode interposed therebetween) so as to narrow the electrode interval and increase the intensity of the electric field. In this case, however, the openings (i.e., the portions of the substrate having no electrodes, and hence light can pass therethrough) are narrowed and increased in number, whereby the area of boundary portions (the edges defining the openings) is relatively increased. At the boundary portions, the Kerr effect is hard to exhibit because of, for example, reduction of the horizontal component of the electric field, which causes a problem that the luminance (display luminance) during bright display is liable to become lower at each boundary portion than at the center of each opening.

Because of the above, to obtain a sufficient display luminance, the interval between the pixel and counter electrodes cannot significantly be narrowed and the driving voltage cannot significantly be reduced.

Further, where the openings are narrow, static electricity shielding effect is increased, and hence the electric field directed from the substrate with the electrodes to the opposing substrate is further weakened. Namely, the liquid crystal layer near the substrate with no electrodes contains lots of liquid crystal molecules, on which an external electric field cannot be easily exerted and which do not show an electric field response (do not perform display operation) even when an electric field is applied thereto. Accordingly, in the liquid crystal layer, the ratio (i.e., the efficiency of use of the layer for display) of the region exhibiting the electric field response may well be reduced.

In addition, if the liquid crystal layer is too thick, since lots of liquid crystal molecules that do not show an electric field response exist in the vicinity of the side on which electrodes are not provided, leakage of light due to selective reflection or diffusion effect from the inside of the liquid crystal layer is increased in the pixels to be subjected to bright display. This results in reduction of contrast. On the other hand, if the liquid crystal layer is too thin, the luminance during bright display will be reduced.

In the liquid crystal region close to the substrate with the electrodes provided thereon, the thickness of the region in which the optical anisotropy induced by the electric field is significant is called an effective cell gap. The inventors found that even in the cells having IPS electrodes and the same cell gap, their effective cell gap varies when the pattern cycle of the electrodes is varied. In other words, the inventors found that the effective cell gap varies in proportion to the half of the electrode pattern cycle (pitch P), i.e., in proportion to the sum (L+S) of the width L of the pixel and counter electrodes and the distance S therebetween, which are as viewed in the direction in which the electrodes are arranged.

More specifically, it was found that by narrowing the pitch P of the electrodes and equalizing the thickness of the liquid crystal layer to the effective cell gap acquired with the pitch P, a liquid crystal display apparatus can be produced which has a high efficiency of use of the liquid crystal layer for display, and is operable without setting a driving voltage high. In this liquid crystal display apparatus, leakage of light from the liquid crystal layer is little and therefore a high contrast can be obtained.

In the embodiment, since the ratio of the pitch P of half the electrode pattern to the thickness D of the liquid crystal layer is set within a predetermined range, the ratio of the region in which the optical anisotropy induced by the electric field in the liquid crystal layer is significant can be increased. Namely, in the embodiment, the efficiency of use of the liquid crystal layer for display is high. Further, since the liquid crystal layer is not excessively thick, leakage of light due to selective reflection or diffusion effect from the inside of the liquid crystal layer can be suppressed, thereby realizing a high contrast. Moreover, by using a blue phase liquid crystal material for the liquid crystal layer, a liquid crystal display apparatus capable of a high-speed display can be produced.

An embodiment will now be described in detail with reference to the accompanying drawings. Through the drawings, like reference numbers denote like elements, and no duplicate descriptions will be given thereof.

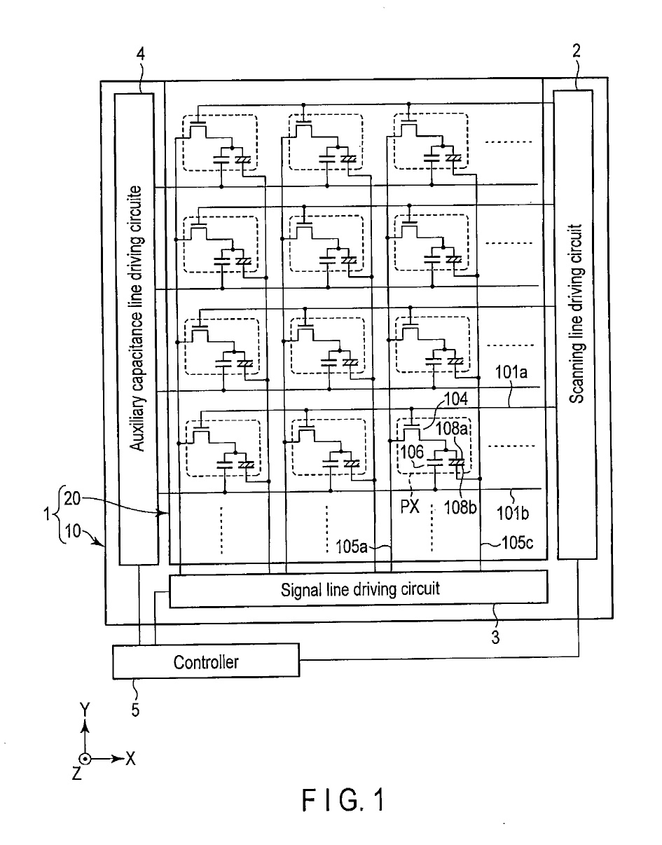

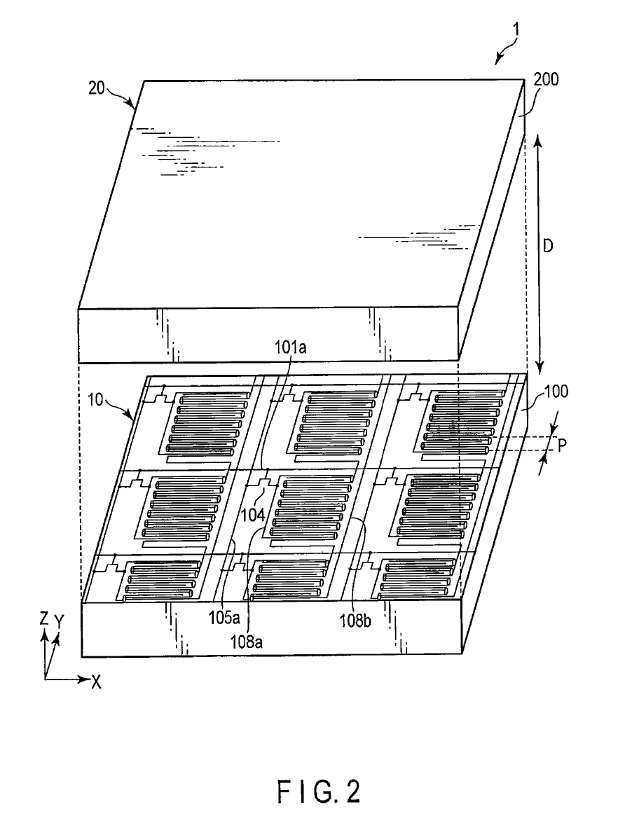

FIG. 1 is a plan view schematically illustrating a liquid crystal display apparatus according to the embodiment. FIG. 2 is an exploded perspective view illustrating the liquid crystal panel shown in FIG. 1. FIG. 3 is a cross-sectional view schematically illustrating a structure example to be employed in the liquid crystal panel of the liquid crystal display apparatus shown in FIG. 2. In FIG. 3, part of the structural elements is omitted for simplification.

The liquid crystal display apparatus of FIG. 1 is an active matrix type liquid crystal display apparatus in which lines are arranged in rows and columns. The liquid crystal display apparatus comprises a liquid crystal display panel 1, a backlight unit (not shown) opposing the panel, a scanning line driving circuit 2 provided on the liquid crystal display panel 1, a signal-line driving circuit 3, an auxiliary capacitance line driving circuit 4, and a controller 5 connected to the signal-line driving circuit 3 and the auxiliary capacitance line driving circuit 4. The lines on the substrate are connected to the scanning line driving circuit 2, the signal-line driving circuit 3 and the auxiliary capacitance line driving circuit 4, in order to apply driving voltages to the liquid crystal layer.

The liquid crystal display panel 1 comprises an array substrate 10 (support substrate) and a counter substrate 20. A frame-shaped seal layer (not shown) is interposed between the array and counter substrates 10 and 20. The space defined by the array and counter substrates 10 and 20 and the seal layer is filled with a liquid crystal material that forms a liquid crystal layer 30 (see FIG. 3).

The array substrate 10 comprises scanning lines 101a and auxiliary capacitance lines 101b. The scanning lines 101a and auxiliary capacitance lines 101b extend along an X-axis and are alternately arranged along a Y-axis perpendicular to the X-axis. The X- and Y-axes are parallel to a major surface of the array substrate 10.

The array substrate 10 also comprises signal lines 105a and power feed lines 105c. The signal lines 105a and power feed lines 105c extend along the Y-axis and are alternately arranged along the X-axis perpendicular to the Y-axis. Alternatively, the signal lines 105a and power feed lines 105c may be extended along the X-axis and alternately arranged along the Y-axis, and the scanning lines 101a and auxiliary capacitance lines 101b be extended along the Y-axis and alternately arranged along the X-axis. Switches 104 are arranged at the respective intersections of the scanning lines 101a and the signal lines 105a. One auxiliary capacitor 106, one pixel electrode 108a and one counter electrode 108b are provided for each of the zones (pixels) that are surrounded with the scanning lines 101a, the auxiliary capacitance lines 101b, the signal lines 105a and the power feed lines 105c. Corresponding switch 104, auxiliary capacitor 106, pixel electrode 108a and counter electrode 108b, provide each pixel PX.

Parts of the scanning line 101a form the gate electrodes 101 (see FIG. 3) of thin-film transistors, described later.

Parts of the auxiliary capacitance lines 101b form the electrodes of capacitors 106.

The scanning lines 101a and the auxiliary capacitance lines 101b are formed in the same process, and are formed of, for example, a metal or an alloy.

The scanning lines 101a are connected to the scanning line driving circuit 2. The scanning line driving circuit 2 sequentially applies, to the scanning lines 101a, a first scanning voltage for controlling the opening and closing of the switches 104. The scanning line driving circuit 2 applies a second scanning voltage for opening the switches 104 to those of the scanning lines 101a to which no first scanning voltage is applied.

The signal lines 105a and the power feed lines 105c are connected to the signal line driving circuit 3. The signal line driving circuit 3 applies a signal voltage to the signal lines 105a, and also applies the power feed lines 105c with a display voltage typically as a constant voltage. The voltage difference between the signal voltage applied to the signal lines 105a and the display voltage applied to the power feed lines 105c is applied to the liquid crystal layer 30 to drive the same. Although the embodiment employs a structure in which a voltage source for applying the display voltage to the power feed lines 105c is included in the signal line driving circuit 3, this voltage source may be provided separate from the signal line driving circuit 3.

The auxiliary capacitance lines 101b are connected to the auxiliary capacitance line driving circuit 4. When the signal line driving circuit 3 reverses, from positive to negative, the polarity of the signal voltage applied to the signal lines 105a, the auxiliary capacitance line driving circuit 4 changes, from a first potential to a second potential, the potential of those of the auxiliary capacitance lines 101b that are connected to pixels PX to which the signal voltage is to be applied, in synchronism with the polarity reverse. Similarly, when the signal line driving circuit 3 reverses, from negative to positive, the polarity of the signal voltage applied to the signal lines 105a, the auxiliary capacitance line driving circuit 4 changes, from the second potential to the first potential, the potential of those of the auxiliary capacitance lines 101b that are connected to the pixels PX to which the signal voltage is to be applied, in synchronism with the polarity reverse. In this embodiment, the polarity of the signal voltage means the polarity of the voltage difference between the signal voltage and the display voltage.

The controller 5 is connected to the scanning line driving circuit 2, the signal-line driving circuit 3 and the auxiliary capacitance line driving circuit 4, to control them.

As shown in FIG. 2, the array substrate 10 of the liquid crystal display apparatus 1 further comprises a light transmissible substrate 100. The substrate 100 is, for example, a glass or plastic substrate.

The counter substrate 20 comprises a light transmissible substrate 200. The substrate 200 is, for example, a glass or plastic substrate. The substrate 100 of the array substrate 10 and the substrate 200 of the counter substrate 20 generally have a thickness of 0.1 to 1 mm, and the liquid crystal layer 30 has a thickness of 1 to 40 μm, more preferably, 2 to 20 μm. The scanning lines 101a, the auxiliary capacitance lines 101b, the signal lines 105a and the power feed lines 105c generally have a width of 1 to 20 μm. Further, one side of each pixel is generally designed to 50 to 500 μm.

As shown in FIG. 3, a color filter 220 is provided on the surface of the counter substrate 20 close to the liquid crystal layer 30.

The color filter 220 comprises a red layer 220R, a green layer 220G and a blue layer 220B. The red layer 220R, the green layer 220G and the blue layer 220B are arranged in stripes corresponding to the rows of the pixels PX. In general, the color filter 220 is set to a thickness of 1 to 10 μm when it is formed together with the other elements of each cell as shown in FIG. 3, and to the same thickness as the substrate when it is attached afterwards. A black matrix (not shown) of a lattice or stripe pattern is provided on the outer edge of the color filter 220.

A granular spacer (not shown) is interposed between the array substrate 10 and the counter substrate 20.

The liquid crystal layer 30 typically contains a mixture of the liquid crystal material and a chiral agent. The liquid crystal material exhibits blue phase. Namely, the liquid crystal layer 30 exhibits selective reflection and the Kerr effect.

The liquid crystal layer 30 may further contain another material. For instance, if a polymer material having a much greater molar weight than a low-molecular liquid crystal compound is added to the liquid crystal layer 30, the temperature range in which the blue phase is exhibited will be widened. In the embodiment, a mixture of a nematic liquid crystal material and a chiral agent, which has a positive dielectric anisotropy, is used as the liquid crystal material.

As shown in FIG. 2, on the array substrate 10, one pixel electrode 108a (first electrode) and one counter electrode 108b (second electrode) are provided per switch. A plurality of pixel electrodes 108a and a plurality of counter electrodes 108b extend along the X axis, and are alternately arranged in a pattern of a comb. In general, the pixel electrodes 108a and the counter electrodes 108b have a thickness of 10 to 100 nm, and are formed of, for example, indium tin oxide (ITO).

As shown in FIG. 3, a linear polarizer 50R is provided on the outer surface of the array substrate 10. Similarly, a linear polarizer 50F is provided on the outer surface of the counter substrate 20.

A description will be given of gate electrodes 101 connected to each scanning line 101a on the substrate 100, referring to FIG. 3.

The gate electrode 101 is coated with an insulating film 102. The insulating film 102 is formed of, for example, silicon oxide.

A semiconductor layer 103 on the insulating film 102 is aligned with the gate electrode 101, and is formed of, for example, amorphous silicon.

A source electrode 105b and a drain electrode 105d are further provided on the insulating film 102 to cover part of the semiconductor layer 103. The drain electrode 105d, which covers the drain of the semiconductor layer 103, is part of the signal line 105a. The source electrode 105b covers the source of the semiconductor layer 103.

The source electrode 105b, the auxiliary capacitance line 101b, and the insulating film 102 interposed therebetween, provide an auxiliary capacitor 106.

The gate electrode 101, the semiconductor layer 103, the portion of the insulating film 102 interposed between the gate electrode 101 and the semiconductor layer 103, the drain electrode 105d, and the source electrode 105b, provide a thin-film transistor. Thin-film transistors each comprising these elements are used as the switches 104.

The switches 104 are n-channel thin film transistors.

On the insulating film 102, pixel electrodes 108a corresponding to the switches 104 are provided. The pixel electrodes 108a are connected to the respective source electrodes 105b.

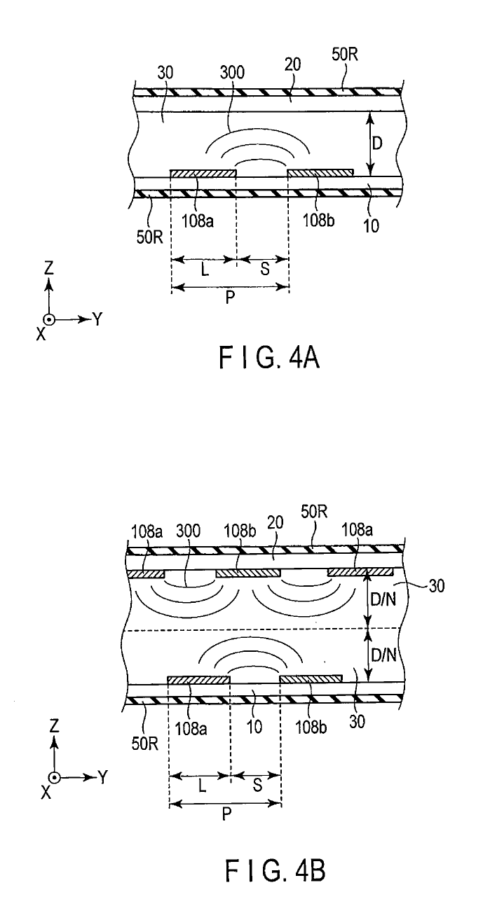

Further, the counter electrodes 108b are connected to the power feed lines 105c, although this is not shown in FIG. 3. FIGS. 4A and 4B show cross-sections of the liquid crystal display panel, taken along the Y axis. FIG. 4A shows one of the pixel electrodes 108a that form part of a comb pattern, and one of the counter electrodes 108b that form the other part of the comb pattern, the one pixel electrode 108a opposing the one counter electrode 108b. In the embodiment, the width of the pixel electrode 108a along the Y axis is equal to the width of the counter electrode 108b along the Y axis.

Assume here that the thickness of the liquid crystal layer 30 is D (see FIG. 2). Namely, assume that the distance between the major surface of the array substrate 10 holding the liquid crystal layer 30, and that of the counter substrate 20 holding the same is set to D as shown in FIG. 4A. Further, assume that the width of the pixel electrode 108a along the Y axis is set to L, and that the distance between the pixel electrode 108a and the counter electrode 108b adjacent thereto along the Y axis is set to S.

If the width L varies depending upon the positions of the pixel electrodes 108a, the average width is set to L.

Similarly, if the distance S varies depending upon the positions of the pixel electrodes 108a and the counter electrodes 108b, the average distance is set to S.

The sum of the width L and the distance S is set to pitch P.

The ratio D/P of the thickness D of the liquid crystal layer 30 to the pitch P thereof is set to a value falling within a range of 0.7 to 2. If the ratio is set within this range, the thickness of the area, in which the optical anisotropy induced by the electric field between the pixel electrode 108a and the counter electrode 108b is significant, becomes equal to the thickness D of the liquid crystal layer 30.

If the ratio D/P is less than 0.7, reduction of the maximum brightness during bright display is increased. In contrast, if the ratio D/P exceeds 2, the portion of the thickness of the liquid crystal layer 30, which is close to the counter substrate 20 and does not contribute to display, is increased in volume. Namely, in this case, the portion of the liquid crystal layer 30 close to the counter substrate 20 contains a small number of liquid crystal molecules responsive to the electric field. Accordingly, this portion does not contribute to display, but leaks, to the outside, the selectively reflected light or the diffused light from within the liquid crystal layer 30. As a result, the resultant display image becomes low in contrast.

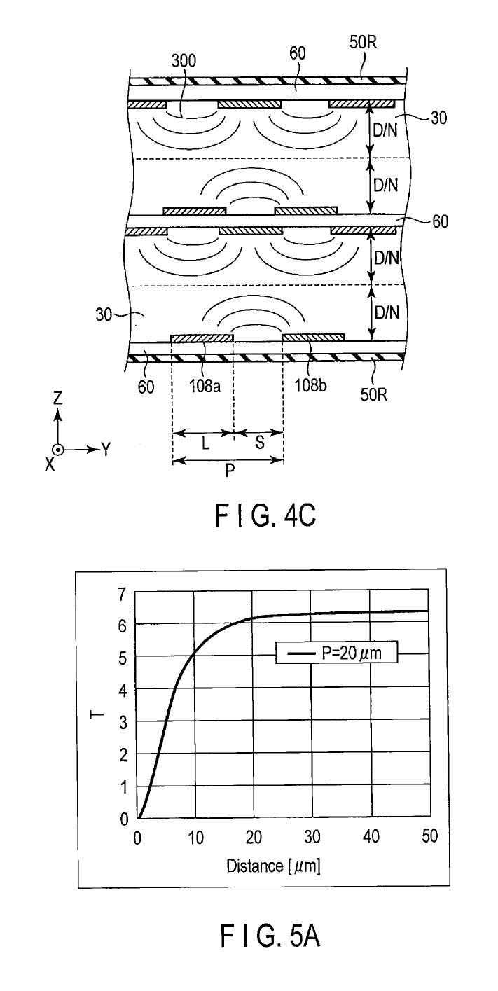

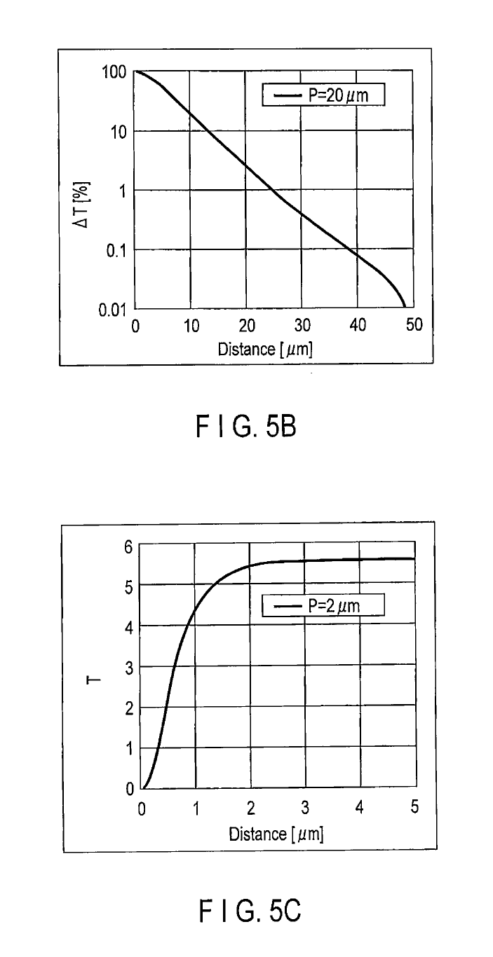

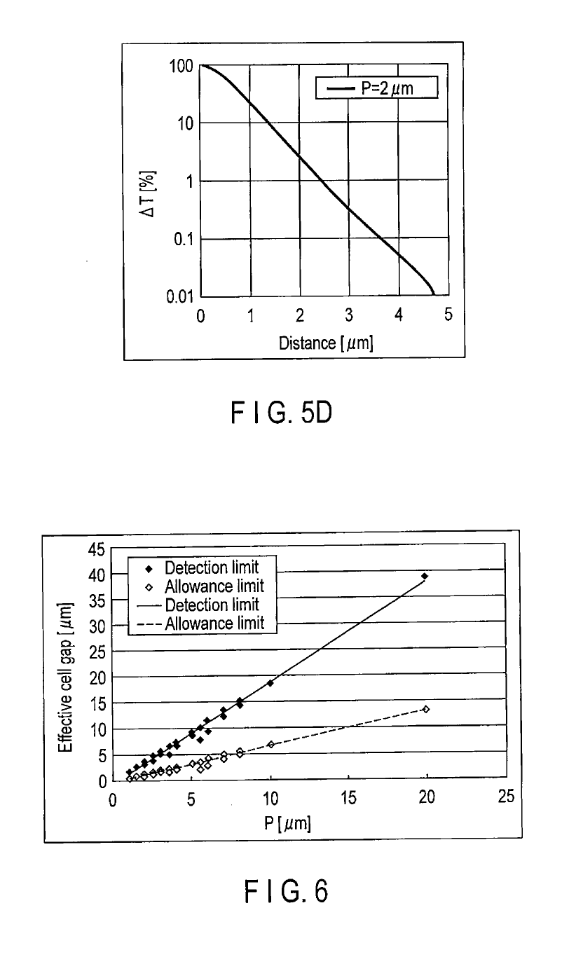

In general, the pixel electrode 108a and the counter electrode 108b, which correspond to each other, are designed to have the same width so that a uniform electric field will occur in parallel with the surface of the array substrate 10. When an electric field is applied, the amount of optical retardation induced thereby and the transmittance T of each pixel depend upon the distance S between the pixel electrode 108a and the counter electrode 108b, and the width L of each of the pixel electrode 108a and the counter electrode 108b. FIGS. 5A to 5D show examples of dependency of the transmittance T on the effective cell gap (=the thickness of the area significant in the optical anisotropy induced by the electric field).

More specifically, FIG. 5A shows the relationship between the transmittance T and the distance of each portion of the liquid crystal layer 30 from the counter substrate 20 assumed when an electrode pattern with a pitch P of 20 μm (L=S=10 μm) is employed. In this case, the maximum distance between the counter substrate 20 and the array substrate 10 is 50 μm. FIG. 5B shows, using logarithm, the relationship between the variation (i.e., the slope in FIG. 5A) of the transmittance T shown in FIG. 5A and the distance of each portion of the liquid crystal layer 30 from the counter substrate 20. FIG. 5C shows the relationship between the transmittance T and the distance of each portion of the liquid crystal layer 30 from the counter substrate 20 assumed when an electrode pattern with a pitch P of 2 μm (L=S=1 μm) is employed. In this case, the maximum distance between the counter substrate 20 and the array substrate 10 is 5 μm. FIG. 5D shows, using logarithm, the relationship between the variation (i.e., the slope in FIG. 5C) of the transmittance T shown in FIG. 5C and the distance of each portion of the liquid crystal layer 30 from the counter substrate 20. The backlight unit is provided close to the array substrate 10.

As is evident from both FIGS. 5A and 5C, the transmittance T is substantially unchanged when the distance between each portion of the liquid crystal layer 30 from the counter substrate 20 is long, whereas it significantly reduces if the distance is short. Namely, it can be understood that when the distance from the array substrate 10 provided with the pixel electrodes 108a and the counter electrodes 108b is too short, the amount of optical retardation induced by the electric field runs short. The area with substantially the same transmittance T contains an effective cell gap (this will be described later in detail).

Because of this, FIGS. 5B and 5D show that the variation of the transmittance T is substantially unchanged when the distance between each portion of the liquid crystal layer 30 from the counter substrate 20 is long, whereas it significantly increases if the distance is short. In FIGS. 5B and 5D, a substantially linear characteristic is exhibited over a wide range. The pitch P in FIG. 5B is 10 times as long as the pitch P in FIG. 5D. On the other hand, the scale of the horizontal axis of FIG. 5B is about 10 times as large as that of the horizontal axis of FIG. 5D. The shape of the curve in FIG. 5B is substantially the same as that of the curve in FIG. 5D. From these figures, it is understood that even if L or S is set to various values, the variation of the transmittance T can be regarded as substantially the same by modifying the scale of the horizontal axis in accordance with the ratio of the pitches P. Namely, the effective cell gap is determined from the pitch P.

In light of the above, the effective cell gap was estimated as follows, using the relationship between the distance between the substrates and the variation of the transmittance: Namely, if the percentage of change of the transmittance T during bright display was not higher than 10%, it was assumed that significant optical anisotropy was induced by an electric field, and the distance between the array substrate 10 and each portion of the liquid crystal layer 30 in which the percentage of change of the transmittance T was 10% was set as a lower limit (allowance limit) for the effective cell gap. Further, if the percentage of change of the transmittance T was not lower than 0.1%, this was regarded as a limit that enables the increase/decrease in the transmittance T to be detected accurately, and the distance between the array substrate 10 and each portion of the liquid crystal layer 30 in which the percentage of change of the transmittance T was 0.1% was set as an upper limit (detection limit) for the effective cell gap.

FIG. 6 shows the relationship between the upper limit and the lower limit of the effective cell gap, and the pitch P of each cell. As is understood from FIG. 6, both the upper limit and the lower limit of the effective cell gap were substantially proportional to the pitch P. The proportionality coefficient indicating the change rate of the effective cell gap relative to the change rate of the pitch P was about 0.7 for the lower limit of the effective cell gap, and about 2 for the upper limit of the effective cell gap. From this, it can be understood that if the ratio D/P of the thickness D of the liquid crystal layer 30 to the pitch P falls within a range of 0.7 to 2, it is unrecognizable that the transmittance T is lower than a maximum value, and a situation in which the transmittance T is significantly low can be avoided.

The width L of the pixel electrode 108a and the counter electrode 108b can be set to an arbitrary value. However, it is desirable to set it to a value falling within a range of 1 to 10 μm that can be formed in a process of forming the switches 104 and wires.

Further, the distance S between the pixel electrode 108a and the counter electrode 108b can be set to an arbitrary value. However, it is desirable to set it to a value falling within the range of 1 to 10 μm, too.

If pixel electrodes 108a and counter electrodes 108b are arranged in the form of plural layers, the display efficiency of the liquid crystal layer can be further enhanced. The case where pixel electrodes 108a and counter electrodes 108b are arranged in the form of plural layers will be described later in detail in Examples 2 and 3. When a plurality of liquid crystal layers 30 are provided, the thickness D is defined as the sum of the thicknesses of the layers 30. Furthermore, when pixel electrodes 108a and counter electrodes 108b are arranged in the form of two or more layers, the ratio D/NP (N is the number of layers in which the pixel electrodes 108a and counter electrodes 108b are arranged) is set to a value falling within the range of 0.7 to 2.

In addition, if the distance S between the corresponding pixel electrode 108a and the counter electrode 108b is set longer than the width L of the pixel electrode 108a, a large aperture area can be obtained and hence a liquid crystal display apparatus of bright display can be obtained.

The shapes and arrangements of the pixel electrodes 108a and the counter electrodes 108b may be modified in various ways.

The pixel electrodes 108a and the counter electrodes 108b may be covered with insulating films. The insulating films may be transparent inorganic films formed of, for example, silicon oxide films or silicon nitride films, or may be transparent organic films.

If the counter electrodes 108b adjacent to each other along the Y axis are connected to each other, the power feed lines 105c can be omitted.

A phase difference plate (not shown) may be interposed on the outer surface of the substrate between a substrate and a linear polarizer for the purpose of, for example, viewing angle compensation.

The above-mentioned technique may be applied to a reflective liquid crystal display apparatus or a transflective liquid crystal display apparatus, instead of the transmissive liquid crystal display apparatus.

Further, although the liquid crystal display apparatus of the embodiment employs an active matrix driving scheme, it may also employ another driving scheme, such as a passive matrix driving scheme or a segment driving scheme.

The driving circuits 2 to 4 may be connected using a chip on glass (COG) technique, or using a tape carrier package (TCP) technique.

Although in the embodiment, the switches 104 are formed of n-channel thin-film transistors, they may be formed of other switching elements, such as p-channel thin-film transistors or diodes.

### Example 1

Examples of the embodiment will now be described.

In the first example, the liquid crystal display apparatus described above with reference to FIGS. 1 to 3 was produced by the method described below.

On a glass substrate 100 as the array substrate 10, the scanning lines 101a, the auxiliary capacitance lines 101b, the switches 104, the signal lines 105a, the power feed lines 105c and the auxiliary capacitors 106 were formed. On the resultant structure, an insulating film formed of silicon nitride was deposited, and then contact holes for connecting to the pixel electrodes 108a and the counter electrodes 108b, which would be formed later, were formed.

Subsequently, the pixel electrodes 108a and the counter electrodes 108b, which were formed of ITO, were provided on the insulating film so that they were embedded into the aforementioned contact holes. More specifically, the ITO layer was provided on the entire surface of the insulating film, and patterned by photolithography to form the pixel electrodes 108a and the counter electrodes 108b. The pixel electrodes 108a and the counter electrodes 108b are oriented in one direction. In the comb-shaped pattern of the pixel electrodes 108a and the counter electrodes 108b, the pixel electrodes 108a and the counter electrodes 108b were formed to have a width L of 3 μm, and the distance S between each pair of adjacent pixel and counter electrodes was set to 3 μm. Accordingly, the pitch P is 6 μm. Further, the counter substrate 20 was formed by forming, on the glass substrate 200, a chromium film as a black matrix, and then providing thereon a stripe color filter 220 formed of photosensitive acrylic resin mixed with red, green and blue pigments.

On the resultant structure, a plurality of rectangular spacers (not shown) having a height of 5 μm and a bottom area of 5 μm×10 μm were formed, using photolithography, so that they would position above signal lines 105a when the array substrate 10 and the counter substrate 20 are attached to each other. After the major surface of the counter substrate 20 was dispensed with an epoxy adhesive to form a frame with an inlet, the array substrate 10 and the counter substrate 20 were assembled to each other and hardened in pressure.

Subsequently, a liquid crystal material was injected into the thus-obtained vacant cell (i.e., a hollow liquid crystal cell formed between the array substrate 10 and the counter substrate 20) through its inlet. As the liquid crystal material, a composition was used which contains 48.2 mol % of nematic liquid crystal JC1041 (produced by Chisso Corporation), 47.4 mol % of nematic liquid crystal 5CB (produced by Sigma-Aldrich Japan K.K.), and 4.4 mol % of chiral dopant ZLI-4572 (produced by Merck Ltd.). The liquid crystal layer exhibited a blue phase.

After that, the inlet was sealed by an epoxy adhesive. As a result, a liquid crystal cell was obtained. The cell gap of the liquid crystal cell (i.e., the distance between the array substrate 10 and the counter substrate 20) D was about 5 μm. Accordingly, the ratio D/P (5 μm/6 μm) is about 0.83 that falls within the range of 0.7 to 2.

Thereafter, the linear polarizer 50R was attached to the outer surface of the array substrate 10. Further, the linear polarizer 50F was attached to the outer surface of the counter substrate 20. The linear polarizers 50R and 50F were attached so that their transmission axes would be at 45 degrees with respect to the X and Y axes and would be perpendicular to each other.

After that, the driving circuits 2 to 4, etc., were connected to the array substrate 10, and the driving circuits 2 to 4 were connected to the controller 5. Further, a backlight unit (not shown) was attached to the resultant display panel 1, thereby completing a liquid crystal display apparatus.

The completed liquid crystal display apparatus was driven to check its performance. Specifically, the voltage applied between the pixel electrode 108a and counter electrode 108b of each pixel PX was changed with a frequency of 120 Hz. After changing the amplitude of the applied voltage between 0 V and ±50 V to thereby measure the transmittance, it was found that a maximum transmittance can be obtained at a voltage of ±25 V. Subsequently, a response time was measured with the applied voltage set at ±25 V. As a result, a response time of 1 ms was obtained. Namely, the liquid crystal display apparatus of Example 1 exhibited a quick response time at a low applied voltage.

Further, the contrast ratio of the liquid crystal display apparatus of Example 1 was 200:1.

Thus, a liquid crystal display apparatus with a high efficiency of use of a liquid crystal layer for display and a high contrast can be obtained.

### Comparative Example 1

A comparative liquid crystal display apparatus was produced, with the thickness D (i.e., the distance between the array and counter substrates 10 and 20) of the liquid crystal layer, the width L of each of the pixel electrode 108a and the counter electrode 108b, and the distance S therebetween all set to 5 μm, and with the other conditions set the same as in Example 1. The D/P of this comparative example was 0.5.

Further, the luminance in the bright display of the comparative example was lower than that of Example 1. Accordingly, the contrast ratio of the comparative example was 150:1. Furthermore, the response time was 1.5 ms.

### Comparative Example 2

Another comparative liquid crystal display apparatus was produced, with the thickness D of the liquid crystal layer, the width L of each of the pixel electrode 108a and the counter electrode 108b, and the distance S therebetween set to 15 μm, 3 μm and 3 μm, respectively, and with the other conditions set the same as in Example 1. The D/P of the comparative example 2 was 2.5.

The luminance in the dark display of the comparative example 2 was higher than that of Example 1. Accordingly, the contrast ratio of the comparative example was 50:1. Further, the response time was 1 ms.

### Example 2

In Example 2, on the counter substrate 20 (support substrate), thin-film transistors and pairs of pixel electrodes 108a and counter electrodes 108b were provided, as shown in FIG. 4B, as well as on the array substrate 10 (support substrate). In this case, the installation positions of the pixel electrodes 108a and counter electrodes 108b of the counter substrate 20 were shifted by half the pitch (P/2) relative to those on the array substrate 10. The thickness of the liquid crystal layer 30 was set to 10 μm, and the other conditions were set the same as in Example 1.

The pixel electrodes 108a and the counter electrodes 108b were set to have a width L of 2 μm, and the distance S between each pair of adjacent ones of the pixel and counter electrodes was to 2.5 μm. As a result, the pattern pitch P was 4.5 μm. When Example 2 is made to have the structure shown in FIG. 4B, the pixel and counter electrodes 108a and 108b are provided on two major surfaces, i.e., the major surface of the array substrate 10 and that of the counter substrate 20. Therefore, the ratio D/NP of the thickness D of the liquid crystal layer 30 to the pitch P was set within the range of 0.7 to 2. This range was employed because the areas, in which the optical anisotropy induced by the electric field that is formed by the pixel and counter electrodes is significant, exist on both the array substrate 10 and the counter substrate 20. N is an integer that indicates the number of major surfaces on which the pixel and counter electrodes are provided, and is 2 in Example 2.

Thus, the ratio D/NP of the thickness D of the liquid crystal layer 30 to the pitch P was 1.1 that falls within the range of 0.7 to 2.

If the pixel and counter electrodes 108a and 108b on the counter substrate 20 are shifted by half the pitch (P/2) with respect to those on the array substrate 10, the electrical flux lines 300 occurring on the array substrate side and those occurring on the counter substrate side are alternately arranged, whereby optical retardation can be effectively induced over the area of the liquid crystal layer 30. As a result, a liquid crystal display apparatus of bright display can be obtained.

Subsequently, this liquid crystal display apparatus was driven in the same way as in Example 1 to thereby check its performance, thereby obtaining the same contrast ratio and response time as those of Example 1, and a transmittance substantially twice the transmittance of Example 1.

Thus, a liquid crystal display apparatus with a high efficiency of use of a liquid crystal layer for display and a high contrast could be obtained.

### Example 3

A liquid crystal display apparatus according to Example 3 is shown in FIG. 4C. It comprises three substrates 60 (support substrates), liquid crystal layers 30 are each held between a corresponding pair of adjacent substrates 60, and pixel electrodes 108a and counter electrodes 108b are provided on the major surfaces of the substrates 60 supporting the liquid crystal layers 30. Further, the pixel electrodes 108a and counter electrodes 108b are shifted by half the pitch on the opposite major surfaces of the middle substrate 60. Similarly, on the major surfaces of adjacent substrates 60, the pixel electrodes 108a and counter electrodes 108b are shifted by half the pitch.

In Example 3, two liquid crystal layers 30 are employed, each having a thickness of 10 μm (i.e., a thickness of 20 μm in total). The width L of the pixel electrodes 108a and counter electrodes 108b is 3 μm, and the distance S between adjacent pixel and counter electrodes is 3 μm. Accordingly, the pattern pitch P is 6 μm. The other structures are similar to the corresponding structures of Example 1.

In Example 3, since two liquid crystal layers 30 are employed, the sum of the thicknesses of the two layers 30 is set as the thickness D of the whole liquid crystal layer. Namely, the liquid crystal thickness D of Example 3 is 20 μm. Further, in Example 3, there are four major surfaces provided with the pixel electrodes 108a and counter electrodes 108b, and hence N=4.

Accordingly, the ratio D/NP of the liquid layer thickness D to the pitch P is 0.83, which falls within the range of 0.7 to 2.

The liquid crystal display apparatus of Example 3 was driven in the same way as the apparatus of Example 1, thereby checking the performance of Example 3. As a result, a contrast ratio and a response time equivalent to those of Example 2 were obtained. Further, a transmittance higher than that of Example 2 could be attained. Thus, a liquid crystal display apparatus with a high efficiency of use of a liquid crystal layer for display and a high contrast can be obtained.

Since the pixel electrodes 108a and counter electrodes 108b are shifted by half the pitch between one major surface and another surface opposing the same or between one major surface and another surface opposite to the same, uniform luminance can be achieved as in Example 2. This enables optical retardation to be effectively induced over the area of the liquid crystal layer 30. Further, a larger volume of the liquid crystal layer than in the aforementioned examples can be used for display, a liquid crystal display apparatus of brighter display can be acquired.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal display apparatus comprising:
a support substrate;
a plurality of first electrodes provided on a surface of the support substrate;
a plurality of second electrodes provided on the surface of the support substrate, the first electrodes and the second electrodes being alternately arranged;
a counter substrate opposing the surface on which the first electrodes and the second electrodes are arranged; and
a liquid crystal layer held between the support substrate and the counter substrate and exhibiting Kerr effect,
wherein 0.7≦D/(L+S)≦2 is satisfied, L being an average width of at least two of the first electrodes and the second electrodes as viewed in a direction in which the first electrodes and the second electrodes are arranged, S being an average distance between at least two pairs of adjacent ones of the first electrodes and the second electrodes, D being a distance between the support substrate and the counter substrate.

2. The apparatus according to claim 1, wherein the average distance S is longer than the average width L.

3. A liquid crystal display apparatus comprising:
a support substrate;
a counter substrate opposing the support substrate;
a plurality of first electrodes provided on major surfaces of the support substrate and the counter substrate opposing each other;
a plurality of second electrodes provided on the major surfaces of the support substrate and the counter substrate, the first electrodes and second electrodes being alternately arranged; and
a liquid crystal layer held between the support substrate and the counter substrate and exhibiting Kerr effect,
wherein 0.7≦D/2(L+S)≦2 is satisfied, L being an average width of at least two of the first electrodes and at least two of the second electrodes as viewed in a direction in which the first electrodes and the second electrodes are arranged, S being an average distance between at least two pairs of adjacent ones of the first electrodes and the second electrodes, D being a distance between the support substrate and the counter substrate.

4. The apparatus according to claim 3, wherein positions of the first electrodes and the second electrodes provided on the support substrate are shifted by (L+S)/2 with respect to respective positions of the first electrodes and the second electrodes provided on the counter substrate.

5. A liquid crystal display apparatus comprising:
a plurality of support substrates opposing each other;
a plurality of liquid crystal layers held between each pair of adjacent ones of the support substrates and exhibiting Kerr effect;
a plurality of first electrodes provided on major surfaces of the support substrates, the major surfaces supporting the liquid crystal layers; and
a plurality of second electrodes provided on the major surfaces of the support substrates, the first electrodes and the second electrodes on each of the major surfaces being alternately arranged;
wherein 0.7≦D/N(L+S)≦2 is satisfied, L being an average width of at least two of the first electrodes and at least two of the second electrodes as viewed in a direction in which the first electrodes and the second electrodes are arranged, S being an average distance between at least two pairs of adjacent ones of the first electrodes and the second electrodes, D being a sum of thicknesses of the liquid crystal layers, N being a number of the major surfaces of the support substrates provided with the first electrodes and the second electrodes.

6. The apparatus according to claim 5, wherein positions of the first electrodes and the second electrodes provided on each of the major surfaces of the support substrates are shifted by (L+S)/2 with respect to respective positions of the first electrodes and the second electrodes provided on another of the major surfaces opposing the each of the major surfaces.
